(19) United States
(12) Patent Application Publication
(10) Pub. No.: US 2026/0295880 A1
(43) Pub. Date: Oct. 1, 2026

(54) Magnetic Sheath for Universal Ambidextrous Retention of Knives and Tools

(71) Applicants: JOHN PAUL KELNER, Bristol, CT (US); William Forster, East Granby, CT (US)

(72) Inventors: JOHN PAUL KELNER, Bristol, CT (US); William Forster, East Granby, CT (US)

(21) Appl. No.: 19/094,959

(22) Filed: Mar. 30, 2025

(51) Int. Cl. B26B 29/02; A45F 5/00

(52) U.S. Cl. CPC B26B 29/025; A45F 5/1575; A45F 2005/002

(57) ABSTRACT

The Magnetic Sheath for Universal Ambidextrous Retention of Knives and Tools is an innovative solution for securely retaining ferromagnetic knives and tools. This design utilizes neodymium pot magnets embedded within a detachable magnet plate to deliver strong magnetic retention, and its modular design allows for universal compatibility with various blade sizes, while integrated drainage openings enable debris and liquids to pass through, enhancing utility in adverse environments, and a cotter pin allows for tool-free disassembly for field servicing and customization. The ambidextrous configuration permits convenient sheathing and unsheathing with either hand, and mounting holes are spaced for compatibility with standard belt clips and retention systems, supporting multiple carry configurations. Designed for military, law enforcement, and outdoorsmen this sheath eliminates reliance on friction-based retention, offering a secure, adaptable, and low-profile storage solution that maintains both tool accessibility and retention integrity in demanding conditions.

### BACKGROUND OF THE INVENTION

Edged weapon and tool retention is an established field, with a multitude of innovative solutions over the years. Most knife/tool holsters today are thermoformed/injection molded nylon, thermoformed Kydex, leather or fabric, and use rudimentary means to retain the knife such as friction or button clasps/velcro. all are antiquated designs which are slow and inefficient to use, and can be arduous to service and uncomfortable to utilize. Traditional universal leather and nylon sheaths are slower to use due to the need for button clasps, Velcro, or elastic bands. Formed Kydex and nylon sheaths are tool-specific, making them unusable for other knives or tools. Kydex/Nylon molded sheaths also become unreliable if debris accumulates in the sheath or if the tool deforms, making them unsafe or unusable. Furthermore, Kydex and nylon sheaths lose all retention once the knife or tool is pulled beyond the retention point, which can be a safety issue in dynamic environments. Other magnetic retention systems on the market are bulky and designed for stationary storage (such as kitchen knife holders or wall mounts), not for personal daily carry. They also fail to cover the blade edge, which is necessary for safety and edge protection. Additionally, the existing sheaths on the market also struggle to accommodate left handed and right handed users, as custom formed/molded sheaths are distinct to the orientation of the knife/tool when they are made. What is needed is a Universal Ambidextrous Magnetic Retention Sheath system, that allows ambidextrous draw and reinsertion, accepts a broad array of aftermarket belt clips, is field serviceable to prevent debris build up, and uses a high-flux-density rectangular pot magnet to apply a significant magnetic retention force.

### SUMMARY OF THE INVENTION

The sheath uses internally retained neodymium pot magnets to magnetically secure a knife or tool upon insertion. Specifically, rectangular pot magnets were chosen for their ability to concentrate magnetic fields within millimeters of the surface. This design ensures that all flux lines travel through the inserted knife or tool, creating a strong retention force. The plastic face thickness between the magnet and the tool can be adjusted to fine-tune grip strength, and magnet size can also be modified for increased retention. As the knife/tool is inserted into the sheath, it becomes magnetized and adhered to the magnet plate. As soon as the knife/tool is in contact with the Magnet Plate, it will take the same amount of force to insert the knife/tool as it takes to withdraw it. This makes it easy to draw and reinsert the knife deliberately, but difficult and unlikely to unsheathe accidentally.

Additional features include:
Drainage & Debris Control: Drain holes and a broad sheath throat allow water and debris to fall through, ensuring usability in dirty or wet conditions.
Friction Enhancement: The sheath can be optionally modified with a rubber contact face. The magnetic pull increases friction between the sheath and tool, and adding rubber further enhances grip—useful for high-intensity, highly dynamic environments like military, police, or construction sites.
Universal Retention: Unlike formed sheaths that require a specific depth for retention, this sheath provides constant magnetic retention from insertion to withdrawal, preventing accidental loss due to inertia shifts.
Serviceability: A standard cotter pin secures the magnet plate, allowing for easy disassembly into two parts—the main chassis and the magnet plate—without the need for specialized tools, making it more field serviceable. Cotter pins were chosen for their affordability, availability, and ease of removal, ensuring field serviceability with minimal tools.
Mounting Compatibility: The chassis has a unique mounting hole pattern, designed to fit almost all available sheath belt clips on the market, allowing users to choose the best mounting option, angle and orientation for their needs and desired carry profile.
Ambidextrous Knife and Tool Retention: The sheath's open design and magnetic retention system allow for ambidextrous insertion and removal of knives and tools without requiring modifications.
Magnetic Field Safety: Rectangular pot magnets were selected due to their concentrated and tight magnetic fields, reducing risk of possible interference with electronics, credit cards, and passports, etc. . . . but providing incredibly strong magnetic grip across the surface of the magnet. Pot magnets' tight magnetic fields make them superior for this application because they have stronger retention strengths and do not have broad fields like standard neodymium magnets, which can wipe credit cards or sensitive data storage mediums and cause various forms of disruption to sensitive materials and devices.

This design is distinct from US011000113B2, as it does not rely on magnets for tactile feedback but rather is specifically designed to avoid tactile feedback/interference, and instead magnetism is used solely for strong and direct retention of ferromagnetic tools.

### BRIEF DESCRIPTION OF THE DRAWINGS

FIG. 1: Isometric View of the Assembled Sheath
This figure depicts the sheath in its fully assembled state with a knife inserted. The Magnet Plate (depicted as shaded in green), Main Chassis (depicted and shaded in white) and cotter pin (depicted shaded in gray) are in their operational positions, securing the knife within the sheath. These components will be shown in a partially disassembled state in FIG. 2 to illustrate their functionality.

FIG. 2: Exploded View of the Sheath
This figure shows the sheath in a partially disassembled state, with the example knife shown as being withdrawn and the cotter pin removed. The Magnet Plate (green) is visible, demonstrating how it nests into the main chassis. The sheath's unique mounting hole pattern is also visible which is spaced and arrayed to accommodate almost all aftermarket belt/waistband clips. This exploded view also serves to demonstrate the modular design and the intended ease of serviceability.

FIG. 3: Magnetic Plate and Retention System
This figure provides a close-up view of the magnet plate and the neodymium pot magnet and its orientation within the sheath. A facsimile of the rectangular neodymium pot magnet is clearly visible, illustrating the general area it will be embedded within the magnet plate and also its size and shape relative to the sheath. This figure also features another perspective of the disassembled sheath, but from the opposite side as FIG. 2

FIG. 4: Perspective Views of the Sheath
FIG. 4 offers a multi-perspective view of the fully assembled sheath, and all of its components

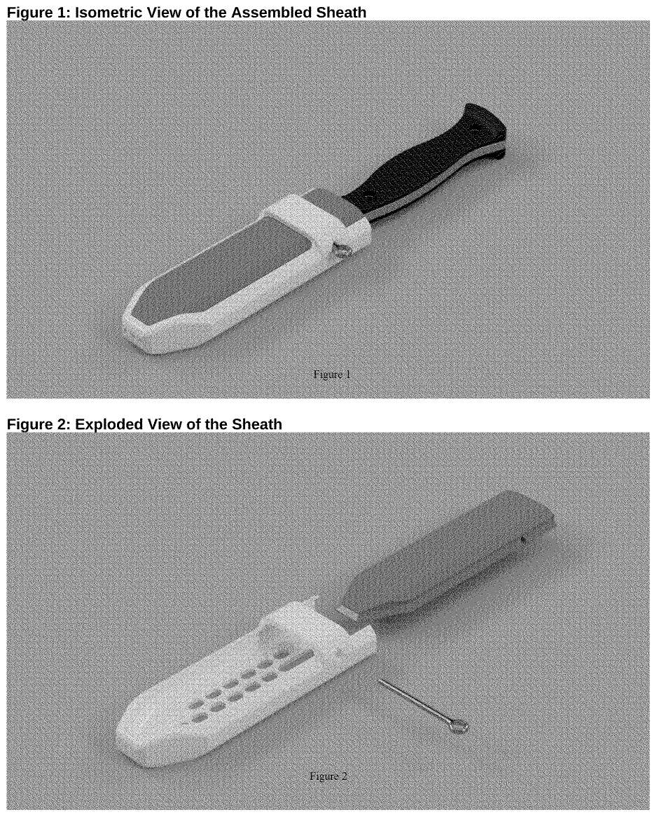

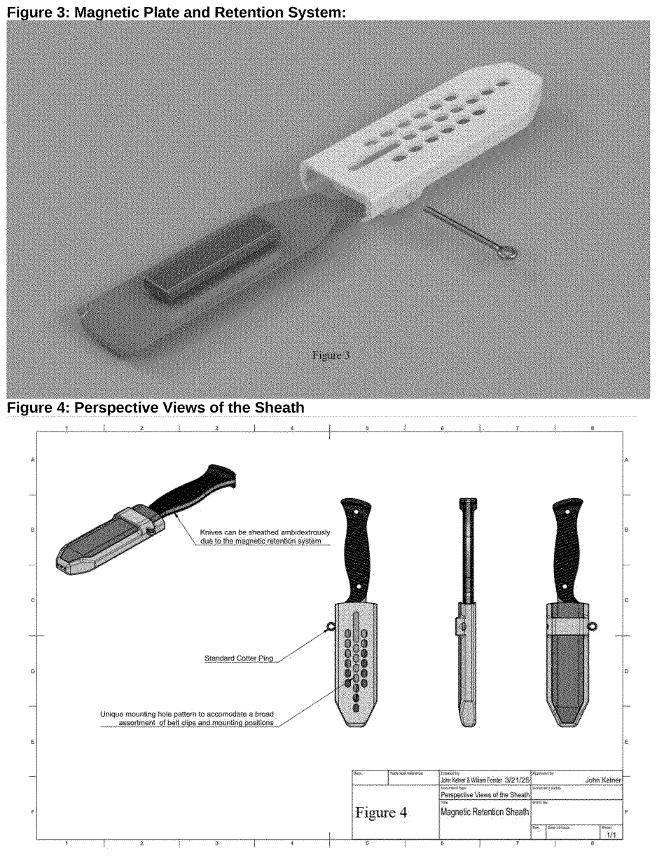

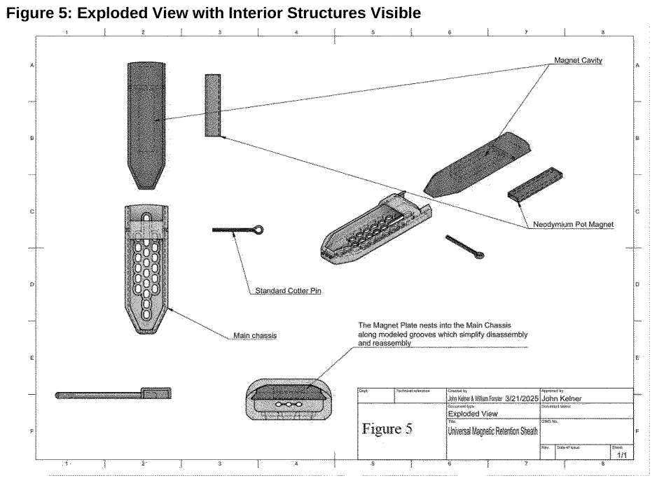

FIG. 5: Exploded View With Interior Structures Visible
This figure features illustrations of the rectangular neodymium pot magnet as well as illustrations of the cavity into which it is embedded. This figure is meant to illustrate the discrete structures within the sheath in order to illustrate how it is assembled. This figure also features a perspective from the mouth of the sheath demonstrating the geometry of the Magnet Plate and the shape of the channels that are modeled into the Main Chassis in order to allow for easy disassembly and reassembly when servicing the sheath.

### DETAILED DESCRIPTION OF THE INVENTION

[symbol]

1. A universal sheath designed for securely retaining knives and tools with ferromagnetic bodies, comprising:
A main chassis featuring an open structure to accommodate various blade and
tool sizes.
A high-flux-density neodymium pot magnet embedded within a detachable magnet plate to provide adjustable magnetic retention.
A cotter pin mechanism enabling easy disassembly and reassembly for maintenance, customization, and field servicing.
Integrated drainage openings within the sheath body to allow the passage of debris and liquids, preventing clogging and obstructions.
An ambidextrous design facilitating sheathing and unsheathing from either direction without requiring modifications.
Pre-configured universal mounting holes compatible with standard and exotic belt clips and retention systems for multiple carry options.

2. The sheath of claim 1, wherein the magnet plate is designed with guiding grooves that facilitate precise alignment and secure nesting within the main chassis.

3. The sheath of claim 1, wherein the magnetic retention force is tunable by modifying the thickness of the sheath material separating the tool from the embedded magnet.

4. The sheath of claim 1, further comprising an optional friction-enhancing rubber contact face to supplement the magnetic retention force, providing additional grip in dynamic environments.

5. The sheath of claim 1, wherein the cotter pin mechanism allows tool-free disassembly, enabling rapid maintenance and replacement of internal components without specialized tools.

6. The sheath of claim 1, wherein the magnetic field is concentrated within the sheath structure to minimize external magnetic interference with sensitive electronics and personal items.

7. The sheath of claim 1, wherein the sheath's internal geometry is structured to guide the tool into proper alignment upon insertion, optimizing magnetic engagement and ensuring a secure fit.

8. The sheath of claim 1, further comprising a reinforced polymer construction for enhanced durability, impact resistance, and prolonged service life in rugged environments.

9. The sheath of claim 1, wherein the magnet plate is interchangeable, allowing users to swap magnet configurations for customized retention strengths based on specific tool requirements.

10. The sheath of claim 1, wherein the sheath is engineered to securely hold tools of varying lengths and widths without the need for additional locking mechanisms or retention straps.
